(19) United States
(12) Patent Application Publication
(10) Pub. No.: US 2026/0307566 A1
(43) Pub. Date: Oct. 8, 2026

(54) SEAT BACK

(71) Applicant: TOYOTA BOSHOKU KABUSHIKI KAISHA, Aichi-ken (JP)

(72) Inventor: Atsushi KANAI, Toyota-shi (JP)

(73) Assignee: TOYOTA BOSHOKU KABUSHIKI KAISHA, Aichi-ken (JP)

(21) Appl. No.: 19/638,576

(22) Filed: Apr. 3, 2026

(30) Foreign Application Priority Data
Apr. 8, 2025 (JP) 2025-063591

(51) Int. Cl. B60N 2/72; B60N 2/68

(52) U.S. Cl. CPC B60N 2/72; B60N 2/68

(57) ABSTRACT

A seat back includes a back frame, a back pad that is a cushion material covering at least a front portion and an upper portion of the back frame, and a bead foam body that is an impact absorbing member attached to an upper rear surface side of the back frame and provided separately from the back pad.

### CROSS-REFERENCE TO RELATED APPLICATION

This application claims priority to Japanese patent application serial number 2025-63591 filed Apr. 8, 2025, the contents of which are incorporated herein by reference in its entirety for all purposes.

### TECHNICAL FIELD

The present disclosure relates to a seat back.

### BACKGROUND

Conventionally, in a seat back of a front seat of a vehicle disposed in front of a rear seat, an impact absorbing material is sometimes disposed on an upper rear surface side of the seat back pad in order to absorb the impact when the head of a rear-seat occupant strikes the upper rear surface side of the seat back during a frontal vehicle collision. For example, in a seat back disclosed in a prior art document, an impact absorbing material made of expanded polystyrene is integrally foamed inside a protruding portion on the upper rear surface side of the seat back pad.

In the seat back described in the above prior art document, the impact absorbing material made of expanded polystyrene that is integrally foamed on the upper rear surface side of the seat back pad can absorb an impact when the head of the rear-seat occupant strikes the upper rear surface side of the seat back during a frontal vehicle collision. However, since the impact absorbing material needs to be integrally foamed at an appropriate position during molding of the seat back pad, there is a problem that manufacturing of the seat back is not easy.

In view of such problems, an object of the present disclosure is to provide a seat back that is easy to manufacture and can ensure the safety of the rear-seat occupant during the frontal vehicle collision.

### SUMMARY

One aspect of the present disclosure is a seat back including a frame forming a framework, a pad body that is a cushion material covering at least a front portion and an upper portion of the frame, and a bead foam body that is an impact absorbing member attached to an upper rear surface side of the frame and provided separately from the pad body.

### BRIEF DESCRIPTION OF DRAWINGS

FIG. 1 is a perspective view of a vehicle seat including a seat back according to one embodiment of the present disclosure, as viewed obliquely from the front.

FIG. 2 is a cross-sectional view taken along line II–II of FIG. 1.

FIG. 3 is a perspective view showing a bead foam body attached to a back frame of the seat back according to the embodiment, as viewed obliquely from the rear.

FIG. 4 is a perspective view showing the bead foam body attached to the back frame of the seat back according to the embodiment, as viewed obliquely from the front.

FIG. 5 is a cross-sectional view taken along line V–V of FIG. 3.

FIG. 6 is a cross-sectional view taken along line VI–VI of FIG. 3.

### DETAILED DESCRIPTION

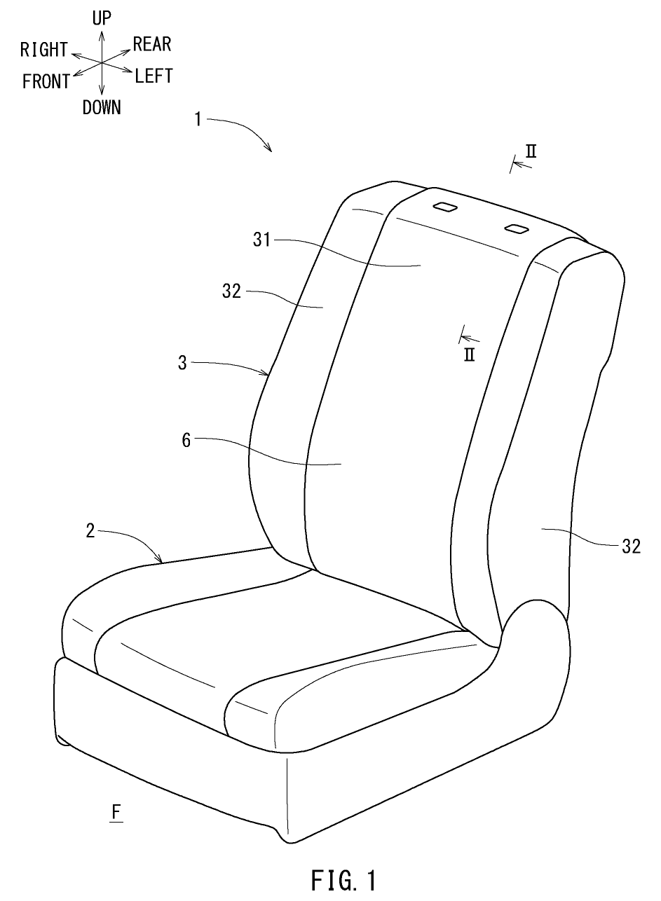

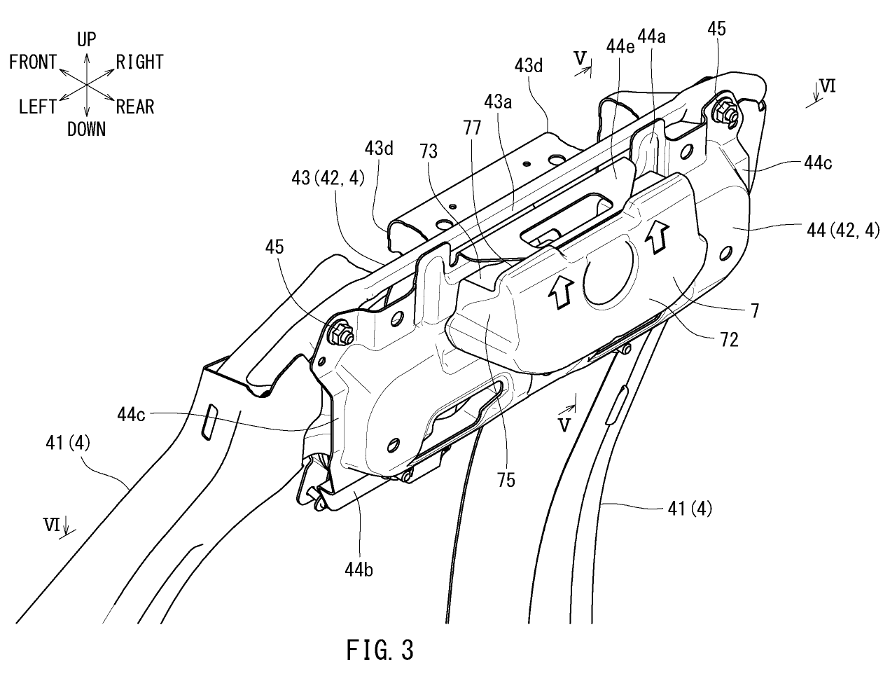

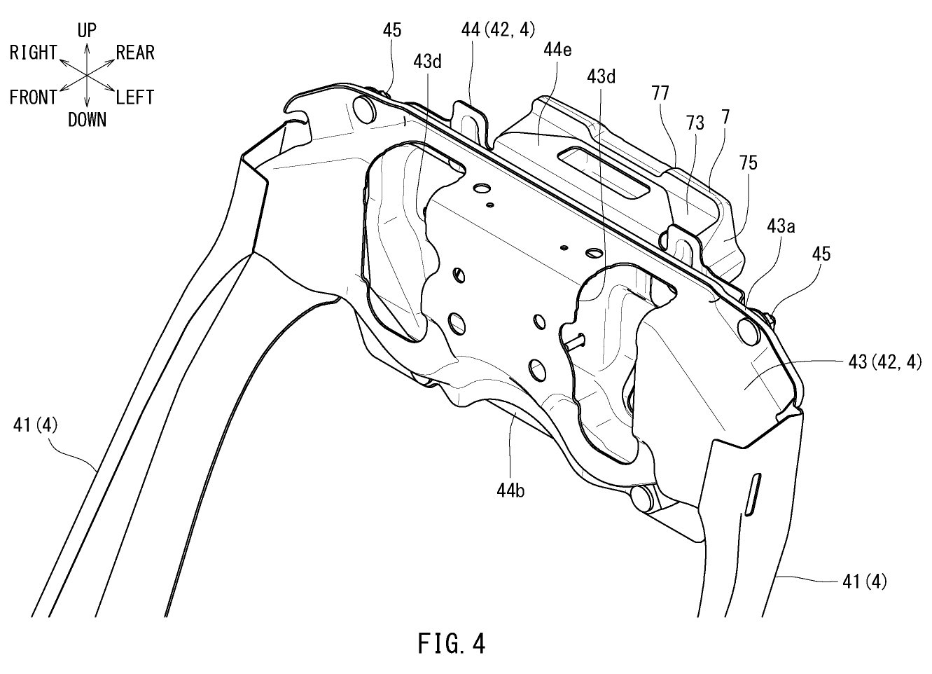

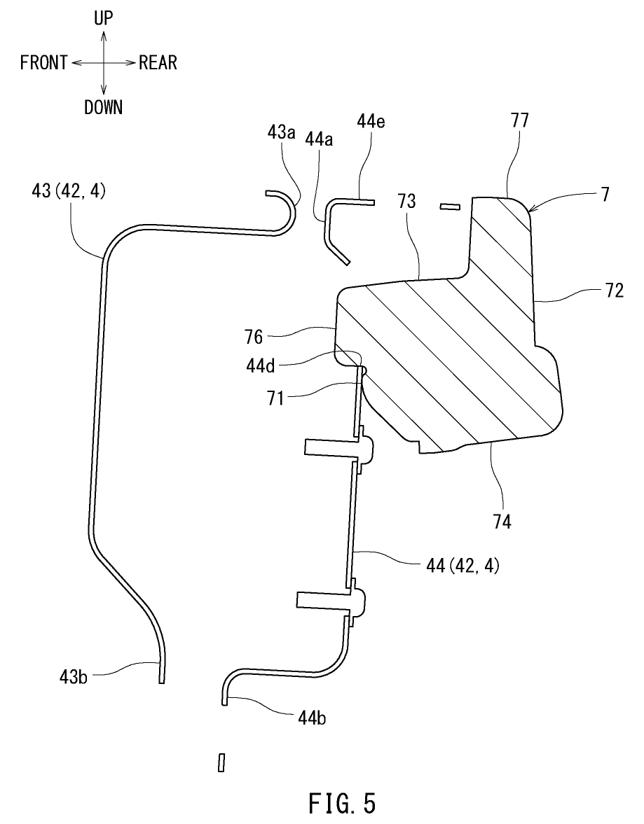

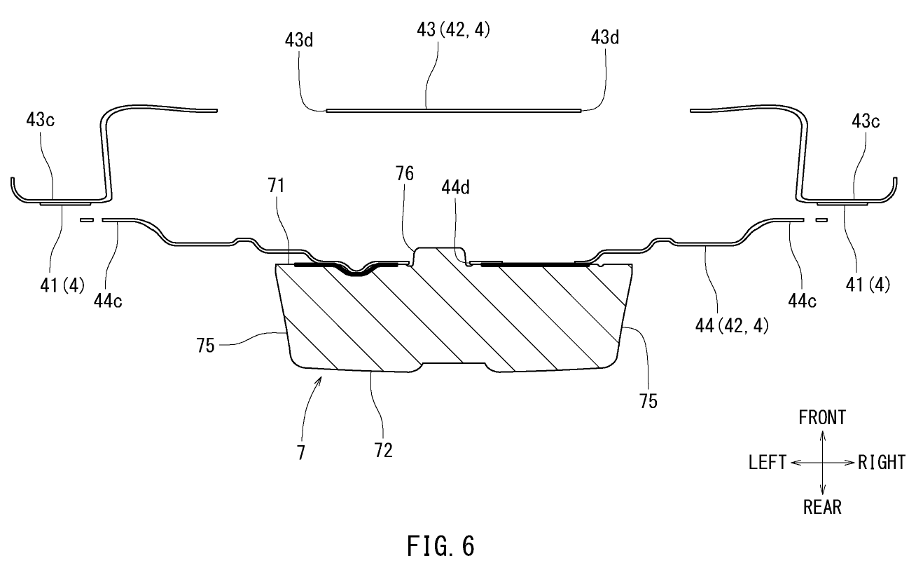

FIGS. 1 to 6 illustrate one embodiment of the present disclosure. This embodiment is an example in which the present disclosure is applied to a seat back 3 of a vehicle seat 1. In the drawings, arrows indicate directions when the vehicle seat 1 is mounted in a vehicle. In the following description, directional references are based on these directions. The vehicle seat 1 includes a seat cushion 2 serving as a seating portion and the seat back 3 serving as a backrest.

As shown in FIG. 1, the seat cushion 2 is placed and fixed on a floor F constituting part of a vehicle body. A lower end portion of the seat back 3 is connected to a rear end portion of the seat cushion 2 via a reclining adjuster (not shown), such that an inclination angle of the seat back 3 relative to the seat cushion 2 in a front-rear direction is adjustable.

As shown in FIGS. 1 to 4, the seat back 3 includes a back frame 4 forming a framework, a back pad 5 that is a cushion material, a back cover 6 that is a cover material, and a bead foam body 7 that is an impact absorbing member. The seat back 3 includes a main portion 31 located at a central portion in a seat width direction and mainly supporting a waist and back of a seated occupant from the rear, and a pair of right and left side portions 32 disposed on both sides of the main portion 31 and mainly supporting the waist and back of the seated occupant from lateral sides. Here, the back frame 4 corresponds to the “frame” recited in the claims, and the back pad 5 corresponds to the “pad body” recited in the claims.

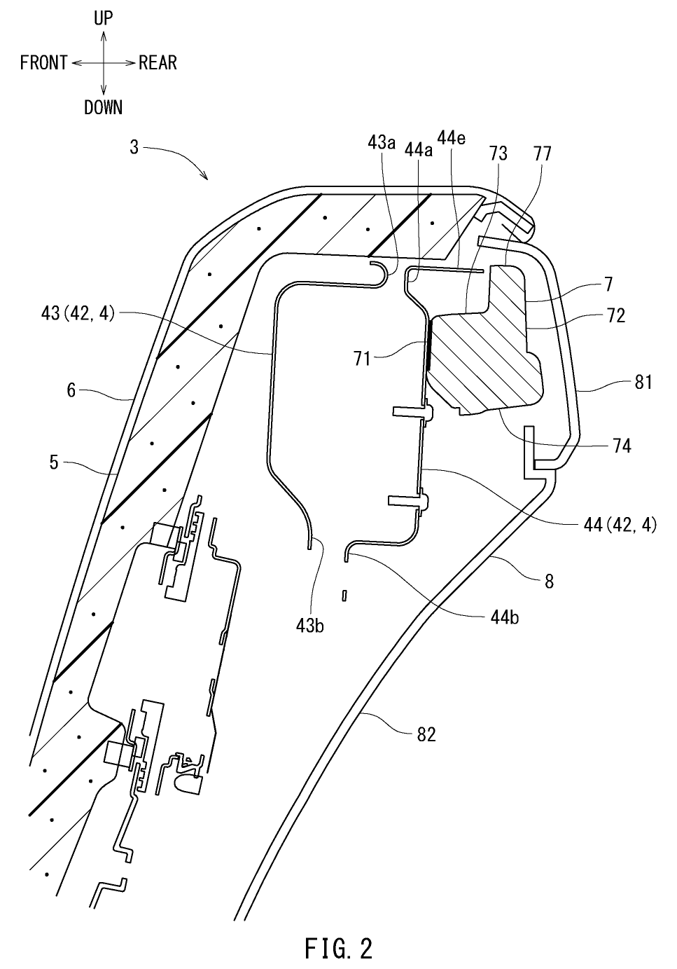

As shown in FIGS. 2 to 4, the back frame 4 includes a pair of right and left side frames 41 extending vertically on right and left side portions, and an upper frame 42 connecting upper end portions of the side frames 41. Each side frame 41 has a substantially U-shaped cross section opening inward in the seat width direction.

As shown in FIGS. 2 to 6, the upper frame 42 includes a front portion 43 having a substantially box shape opening rearward, and a rear portion 44 having a substantially box shape opening forward. The front portion 43 includes an upper flange portion 43a extending substantially upward at an upper end side, a lower flange portion 43b extending substantially downward at a lower end side, and a pair of right and left side flange portions 43c extending outward in the seat width direction at right and left end sides. The front portion 43 is formed with a pair of right and left cutout portions 43d extending vertically. The cutout portions 43d are portions where stays of a foldable headrest (not shown) are disposed so as to be foldable in the front-rear direction. The front portion 43 is connected to the side frames 41 by welding the side flange portions 43c thereto. The rear portion 44 includes an upper flange portion 44a extending substantially upward at an upper end side, a lower flange portion 44b extending substantially downward at a lower end side, and a pair of right and left side flange portions 44c extending outward in the seat width direction at right and left end sides. A substantially rectangular connection hole 44d is formed at a central portion in a right-left direction of the rear portion 44. The connection hole 44d is used to position the bead foam body 7 by inserting a protrusion 76 of the bead foam body 7 when attaching the bead foam body 7 to the rear portion 44. A movement restricting portion 44e extending rearward is formed at a central portion in the right-left direction of the upper flange portion 44a of the rear portion 44. A movement restriction portion 44e functions to restrict forward and upward movement of the bead foam body 7 attached to the rear portion 44 beyond a predetermined amount. The rear portion 44 is connected to the front portion 43 by fastening the upper flange portion 44a to the upper flange portion 43a of the front portion 43 with bolts and nuts 45.

As shown in FIGS. 2 to 6, the bead foam body 7 is a bead-foamed molded body made of an olefin resin such as polyethylene resin or polypropylene resin, and has a density of approximately 0.03 g/cm³. The bead foam body 7 has a higher elastic modulus and is harder than the back pad 5, and has excellent impact absorption capability. The bead foam body 7 has a substantially rectangular parallelepiped shape elongated in the right-left direction, and includes a front surface portion 71, a rear surface portion 72, an upper surface portion 73, a lower surface portion 74, and a pair of right and left side surface portions 75. A dimension of the bead foam body 7 in the right-left direction is set to be slightly shorter than a dimension of the main portion 31 in the right-left direction. A protrusion portion 76 having a substantially rectangular vertical cross section and extending forward is formed at a central portion in the right-left direction of the front surface portion 71. A ridge portion 77 extending upward is formed on a rear end side of the upper surface portion 73. When an impact force is applied to the bead foam body 7 from rear upper side, the ridge portion 77 comes into contact with a rear end portion of the movement restricting portion 44e of the upper frame 42, thereby restricting forward movement beyond a predetermined amount.

As shown in FIG. 2, the back pad 5 is a foamed molded body made of urethane resin and has a density of approximately 0.04 g/cm³, and is mounted so as to cover a front surface portion and an upper surface portion of the back frame 4.

As shown in FIGS. 1 and 2, the back cover 6 is formed in a bag shape opening rearward by sewing together a plurality of pieces. The back cover 6 is fitted onto the back pad 5 attached to the back frame 4 from the front, and by connecting a plurality of front side portions to the back pad 5 and connecting a plurality of outer peripheral edge portions to the back frame 4, the seat back 3 is formed.

As shown in FIG. 2, the seat back 3 is assembled as follows. First, the bead foam body 7 is attached to the rear portion 44 of the upper frame 42 of the back frame 4. At this time, the protrusion portion 76 of the bead foam body 7 is inserted into the connection hole 44d of the rear portion 44 to perform positioning, and the front surface portion 71 of the bead foam body 7 is connected to the rear portion 44 with double-sided tape. Next, the back pad 5 is fitted so as to cover the front surface portion and the upper surface portion of the back frame 4, and the back cover 6 is further fitted thereon and connected to the back pad 5 and the back frame 4. Finally, a resin back board 8 is attached from the rear to make the back pad 5 and the back frame 4 not visible from the outside. The back board 8 is mainly divided into an upper cover portion 81 that covers the rear surface portion 72 of the bead foam body 7 and a lower cover portion 82 that covers a portion below the upper cover portion 81.

In the above embodiment, the bead foam body 7 is fixed to the rear portion 44 using double-sided tape. However, the configuration is not limited thereto. For example, the protrusion portion 76 of the bead foam body 7 may be configured to mechanically engage with the connection hole 44d. Specifically, a plurality of crush ribs (not shown) protruding outward may be formed on an outer peripheral surface of the protrusion portion 76. In this configuration, when the protrusion portion 76 is press-fitted into the connection hole 44d, the crush ribs undergo elastic deformation or plastic deformation against an inner edge of the connection hole 44d, thereby firmly securing the bead foam body 7 to the upper frame 42. This eliminates the need for double-sided tape, reducing the number of components and simplifying the assembly work.

In addition, a noise suppression member may be interposed between the bead foam body 7 and the back frame 4. Since the bead foam body 7 is provided separately from the back pad 5 and is attached directly to the rigid back frame 4, friction noise (squeak noise) may be generated due to vehicle vibrations. To prevent this, a non-woven fabric sheet, a felt member, or a thin urethane layer may be adhered to at least one of the front surface portion 71 of the bead foam body 7 and a rear surface of the rear portion 44 of the upper frame 42. This ensures that the bead foam body 7 and the back frame 4 come into contact via the noise suppression member, thereby preventing the generation of abnormal noise while maintaining the ease of assembly.

The embodiment configured as described above achieves the following effects. The seat back 3 includes the back frame 4, the back pad 5, and the bead foam body 7 that is provided separately from the back pad 5 and attached to an upper rear surface side of the back frame 4. Therefore, it is not necessary to integrally foam the bead foam body 7 with the back pad 5, which facilitates manufacturing of the back pad 5, and the back pad 5 and the bead foam body 7 may be separately attached to the back frame 4. As a result, it is possible to provide a seat back 3 that is easy to manufacture and can ensure the safety of a rear-seat occupant during a frontal vehicle collision.

Further, no back pad 5 is present on a rear surface side of the bead foam body 7 attached to the back frame 4. Accordingly, the bead foam body 7 and the back pad 5 can be attached to the back frame 4 independently of each other without regard to order, thereby increasing flexibility in manufacturing methods.

Furthermore, since the rear of the bead foam body 7 is covered by the back board 8, the bead foam body 7 is not visible from the rear, thereby improving the appearance of the seat back 3 when viewed from the rear.

In addition, a foldable headrest is attached above a portion of the back frame 4 to which the bead foam body 7 is attached. Accordingly, even in the seat back 3 to which a foldable headrest is attached, it is possible to provide a seat back that is easy to manufacture and can ensure the safety of a rear-seat occupant during a frontal vehicle collision.

Although specific embodiments have been described above, the present invention is not limited to the appearances and configurations thereof, and various modifications, additions, and deletions can be made without departing from the gist of the present invention.

In the above embodiment, the back pad 5 is configured as an integral body including the main portion 31 and the pair of right and left side portions 32. However, the configuration is not limited thereto. A configuration may be adopted in which the back pad includes a main pad body located at a central portion in the seat width direction and side pad bodies disposed on both sides of the main pad body, each covered by a cover body, and the bead foam body 7 is disposed behind the main pad body. This also makes it possible to provide a seat back that is easy to manufacture and can ensure the safety of a rear-seat occupant during a frontal vehicle collision even in a seat back in which the pad body is divided into a main pad body and right and left side pad bodies.

In the above embodiment, the bead foam body 7 is made of an olefin resin such as polyethylene resin or polypropylene resin, but is not limited thereto, and may be made of a styrene resin.

In the above embodiment, the present invention is applied to the vehicle seat, but may also be applied to seats mounted in airplanes, ships, trains, and the like.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved seat back, and/or methods of making and using the same.

We claim:

1. A seat back comprising:
a frame forming a framework;
a pad body comprising a cushion material covering at least a front portion and an upper portion of the frame; and
a bead foam body comprising an impact absorbing member attached to an upper rear surface side of the frame, wherein the bead foam body is provided separately from the pad body.

2. The seat back according to claim 1, wherein the pad body is not disposed on a rear surface side of the bead foam body.

3. The seat back according to claim 1, wherein:
the pad body includes a main pad body located at a central portion in a seat width direction and side pad bodies disposed on both sides of the main pad body;
the main pad body and the side pad bodies are each covered by a cover body; and
the bead foam body is disposed on a rear portion of the main pad body.

4. The seat back according to claim 1, further comprising a back board attached to a rear side of the seat back, wherein the back board covers a rear surface portion of the bead foam body.

5. The seat back according to claim 1, wherein a foldable headrest is attached above a portion of the frame to which the bead foam body is attached.

6. The seat back according to claim 1, wherein:
the frame includes a pair of side frames extending vertically and an upper frame connecting upper end portions of the pair of side frames;
a rear portion of the upper frame includes a connection hole;
the bead foam body includes a protrusion portion extending forward from a front surface portion; and
the protrusion portion being configured to be inserted into the connection hole to position the bead foam body relative to the frame.

7. The seat back according to claim 6, wherein the upper frame includes a movement restricting portion extending rearward, and the bead foam body includes a ridge portion extending upward, the ridge portion being configured to contact the movement restricting portion to restrict forward movement of the bead foam body beyond a predetermined amount.

8. The seat back according to claim 4, wherein the back board includes an upper cover portion covering the rear surface portion of the bead foam body and a lower cover portion covering a portion below the upper cover portion.

9. The seat back according to claim 6, wherein the upper frame includes a front portion having a substantially box shape opening rearward and a rear portion having a substantially box shape opening forward.

10. The seat back according to claim 9, wherein the front portion is formed with a pair of cutout portions extending vertically, the cutout portions being configured to accommodate stays of a foldable headrest.

11. The seat back according to claim 9, wherein the rear portion is connected to the front portion by fastening an upper flange portion of the rear portion to an upper flange portion of the front portion with bolts and nuts.

12. The seat back according to claim 1, wherein the bead foam body has a substantially rectangular parallelepiped shape elongated in a right-left direction.

13. A seat back comprising:
a pair of side frames extending vertically;
an upper frame connecting upper end portions of the pair of side frames, wherein the upper frame includes a front portion and a rear portion connected to the front portion;
a pad body covering at least a front side of the upper frame; and
a bead foam body attached to the rear portion of the upper frame, wherein the rear portion of the upper frame includes a connection hole, the bead foam body includes a protrusion portion extending forward from a front surface portion of the bead foam body, and wherein the protrusion portion is inserted into the connection hole to position the bead foam body.

14. The seat back according to claim 13, wherein the rear portion of the upper frame includes a movement restricting portion extending rearward from an upper flange portion, and wherein the bead foam body includes a ridge portion extending upward, the ridge portion being configured to contact the movement restricting portion to restrict forward movement of the bead foam body.

15. The seat back according to claim 14, wherein the front portion and the rear portion of the upper frame are connected to each other by fastening an upper flange portion of the front portion and an upper flange portion of the rear portion together with bolts and nuts.

16. The seat back according to claim 14, wherein the front portion of the upper frame includes a pair of vertically extending cutout portions configured to receive stays of a foldable headrest.

17. The seat back according to claim 14, wherein a front surface portion of the bead foam body is further connected to the rear portion of the upper frame with double-sided tape.

18. The seat back according to claim 14, wherein the front portion of the upper frame has a substantially box shape opening rearward, and wherein the rear portion of the upper frame has a substantially box shape opening forward.
